(19) United States
(12) Patent Application Publication
(10) Pub. No.: US 2016/0303719 A1
(43) Pub. Date: Oct. 20, 2016

(54) OIL FILTER REMOVAL TOOL

(71) Applicant: Thomas L. Klamm, Racine, WI (US)

(72) Inventor: Thomas L. Klamm, Racine, WI (US)

(21) Appl. No.: 14/688,612

(22) Filed: Apr. 16, 2015

(51) Int. Cl. B25B 27/00; B25B 13/50; B25B 13/28

(52) U.S. Cl. CPC B25B 27/0042; B25B 13/28; B25B 13/5008

(57) ABSTRACT

A tool for removing an oil filter from an engine includes a wrench with a body from which a plurality of fingers pivotally project. Each finger has a remote end section from which a projection extends to engage the oil filter. A drive mechanism causes the fingers to pivot with respect to the body. A flexible boot has a curved frusto-conical shape with an open end and a smaller closed end and encloses the wrench. The boot catches and retains oil leakage during removal of an oil filter. A shaft is attached to the drive mechanism of the wrench and extends through the first aperture of the boot. The drive mechanism is adapted to have a handle removably attached thereto.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of the Invention

The present invention relates to tools for removing an oil filter from attachment to an internal combustion engine.

2. Description of the Related Art

An internal combustion engine is lubricated by oil that is circulated through a filter. Periodically the oil and the filter have to be replaced. A typical automobile oil filter is threaded onto a nipple that projects from the engine. A wrench often is required to remove the existing filter and several different types of wrenches have been developed for this purpose. Most of those wrenches are designed to be turned by a standard ratchet type handle.

One common style of an oil filter wrench is a cap with a polygonal sidewall that fits onto the bottom end of the oil filter that has a matching polygonal sidewall. The drawback of this style is that the wrench fits only one size of filter body and a motor vehicle service center or garage needs to have an assortment of such wrenches in different sizes.

Another style of oil filter wrench has movable fingers that adjust to grip different sizes of oil filters. An example of this style of wrench is shown in U.S. design patent D348,814. In order to aid the fingers to grip the filter housing, the ends of the fingers have plastic covers. However, the plastic covers can wear through or fall off and get lost over time. Therefore, a better mechanism for gripping the filter body is desired for this style of oil filter wrench.

Another problem with all styles of oil filter wrenches, is that as the filter is loosened from the engine, oil that remains in the filter and in the adjacent region of the engine leaks out falling onto components of the motor vehicle and the floor there under. The leaking oil also can burn a person's hands. U.S. published patent application no. 2012/0198970 addresses this problem by attaching a cylindrical bellows to a conventional cap style oil filter wrench to catch the leaking oil during removal of an existing oil filter. Because this tool uses a cap style wrench, it only works with one size of oil filter.

Therefore, a need still exists a need for an oil filter wrench that can be used with oil filters of different sizes and catch oil that leaks from the filter during removal.

### SUMMARY OF THE INVENTION

A tool for removing an oil filter from an engine comprises a wrench, a boot surrounding the wrench, and a shaft attached to the wrench and extending out of the boot.

The wrench includes a body from which a plurality of fingers pivotally project. Each finger has a remote end section from which a rod projects in an orientation to engage the oil filter. The wrench further includes a drive mechanism, that when rotated, causes the fingers to pivot with respect to the body.

In one embodiment of the wrench, a circular gear with teeth is rotationally connected to the body. A drive mechanism is attached to the circular gear and is adapted to be engaged by a handle. The plurality of fingers are pivotally connected to the body and curve outward there from in a common plane. Each finger has a proximate end section with teeth that mesh with the teeth of the circular gear and its remote end section is transverse to the common plane.

The boot is fabricated of flexible material and has a curved frusto-conical shape with an open end and a smaller closed end with a first aperture there through. The wrench is located within the boot.

The shaft is attached to the drive mechanism of the wrench and extends through the first aperture of the boot. Rotating the shaft with respect to the wrench body causes the fingers to pivot respect to the wrench body.

In use, the boot is placed over the oil filter to be removed until the oil filter is located between the fingers of the wrench. Then, the shaft is rotated causing the fingers pivot toward the oil filter so that the rods engage and firmly grip the housing of the oil filter. Continued rotation of the shaft causes the wrench and the oil filter to rotate, thereby loosening the oil filter from the engine.

### BRIEF DESCRIPTION OF THE DRAWINGS

FIG. 1 is a side view of an oil filter removal tool according to the present invention;

FIG. 2 is a longitudinal cross-sectional view through the tool in FIG. 1;

FIG. 3 is a top view of a wrench in the tool for gripping an oil filter;

FIG. 4 is a side view of the wrench;

FIG. 5 is a view of the wrench with a top plate removed to show the internal components; and

FIG. 6 is a side view of an oil filter removal tool with its boot in a compressed state.

### DETAILED DESCRIPTION OF THE INVENTION

Reference herein to directional relationships and movement, such as top and bottom or left and right, refer to the relationship and movement of the components in the orientation illustrated in the drawings, which may not be the orientation of the components when the oil filter removal tool is in use.

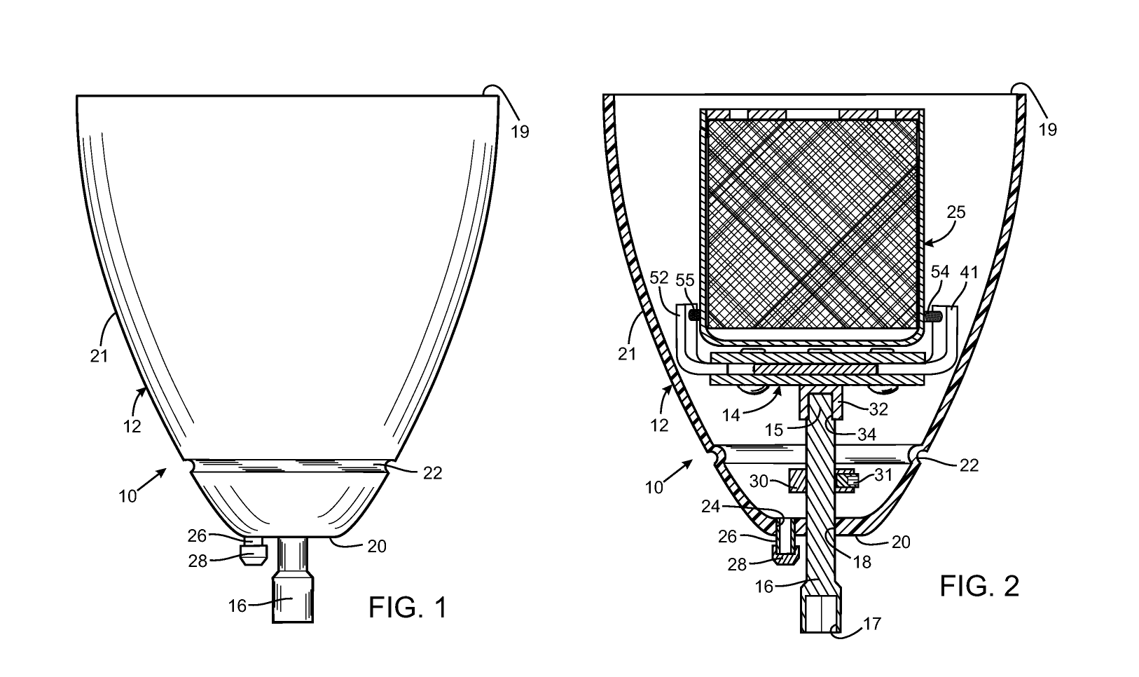

With initial reference to FIGS. 1 and 2, an oil filter removal tool 10 comprises an adjustable oil filter wrench 14 inside a flexible boot 12 and attached to a wrench extension shaft 16 that extends through a first aperture 18 in the boot. The inner end 15 of the wrench extension shaft 16 has a square cross section so as to fit into a square aperture in the oil filter wrench 14 and the outer end has a square aperture 17 for receiving a standard wrench handle (not shown).

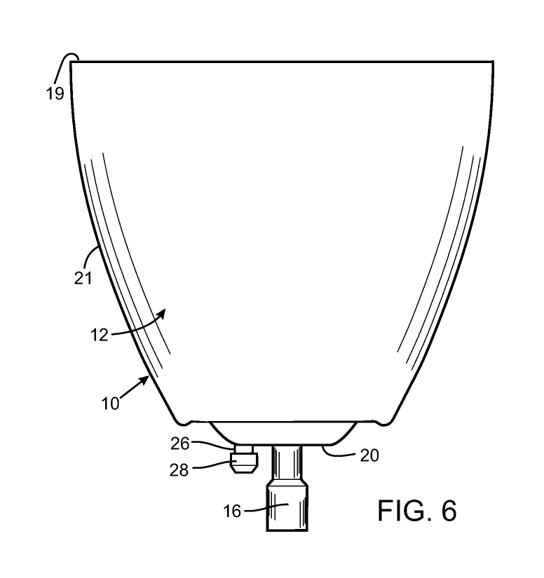

The boot 12 has a curved frusto-conical shape with a circular cross section, similar to half of an American style football divided at the midpoint between its two small ends. The boot 12 surrounds the oil filter wrench 14 and has a first end 19 that is open to allow the boot to extend around the oil filter 25 held in the wrench during removal as shown in FIG. 2. The opposite second end 20 of the boot 12 is closed and is smaller than the first end 19. The exterior surface 21 of the boot is smooth, curving inward going from the relatively large first end 19 to the smaller second end 20. The boot 12 is made of a resilient material, such as rubber or plastic, that is flexible yet retains the frusto-conical normal shape. That resiliency allows the boot to collapse or compress longitudinally to accommodate oil filters of different lengths, as depicted in FIG. 6. Referring again to FIGS. 1 and 2, that compression is facilitated by an annular groove 22 in the exterior surface 21 of the boot 12 and spaced a short distance from the closed second end 20.

The closed second end 20 of the boot has a second aperture 24 therein from which a tubular drain coupling 26 extends outward. A closure, in the form of a removable cap 28, closes the tubular drain coupling 26 and prevents oil from flowing from the boot 12 out through the drain tube. It should be understood that other types of closures, such as a plug for example, may be used to block oil flow through the drain tube.

The wrench extension shaft 16 extends through the first aperture 18 in the closed second end 20 of the boot. The boot wall around the first aperture 18 snuggly engages the wrench extension shaft 16 to prevent oil inside the boot from leaking out, yet that engagement is not so tight as to impede the wrench extension shaft from rotating in the first aperture. Optionally, a seal between the boot and the wrench extension shaft can be provided by an O-ring placed in a groove around the first aperture. The smaller inner end 15 of the wrench extension shaft 16 is able to be pushed through the first aperture 18 during assembly of the tool 10. A collar 30 extends around the interior portion of the wrench extension shaft 16 and is affixed thereto by a set screw 31 or other securing mechanism. Alternatively, the collar 30 may be a snap ring that fits into an annular groove around the wrench extension shaft 16. The collar 30 prevents the wrench extension shaft 16 from inadvertently being pulled out of the boot 12 through the first aperture 18. However, unscrewing the set screw 31 allows the collar 30 to be released so that the wrench extension shaft 16 can be removed from the boot, if necessary.

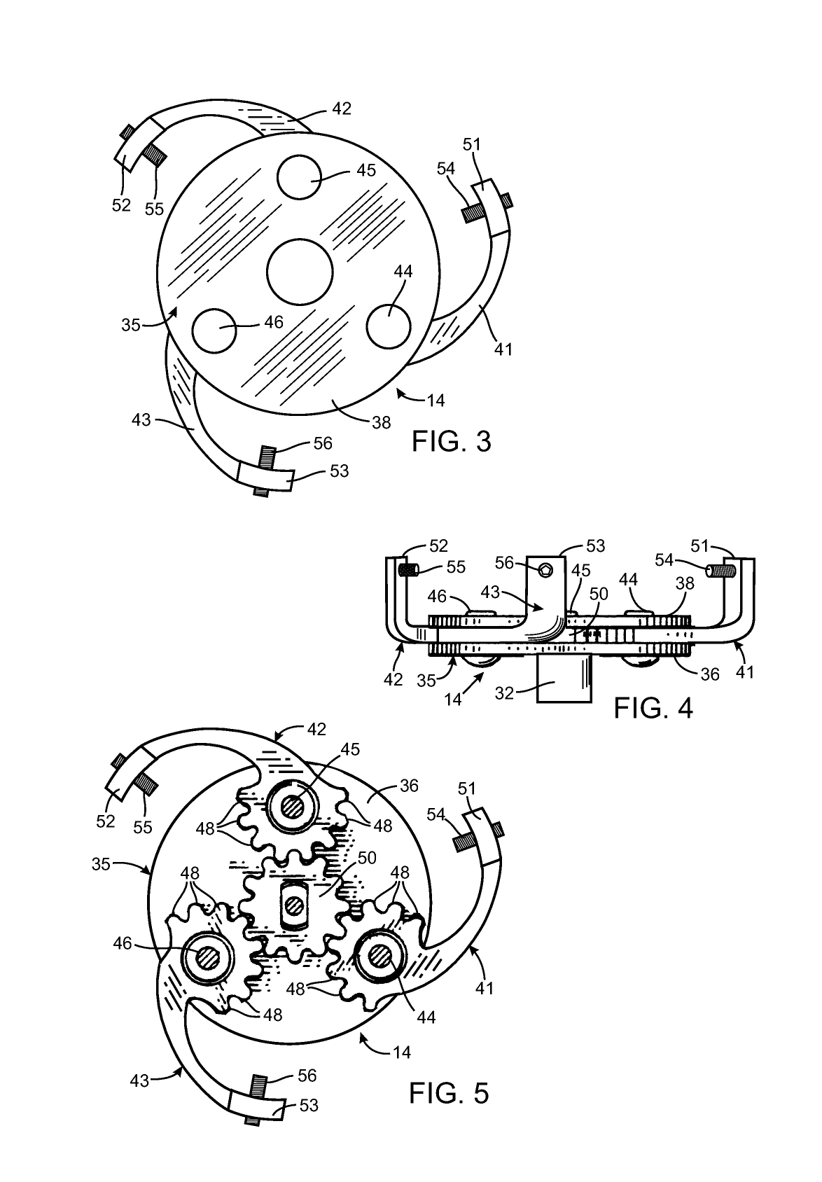

As seen in FIG. 2, the inner end 15 of the wrench extension shaft 16 engages the oil filter wrench 14. For example, that inner end 15 has a square cross-section that removably fits into a square aperture 34 in a drive coupling 32 of the oil filter wrench 14. With additional reference to FIGS. 3-5, the oil filter wrench 14 has a body 35 formed by circular first and second plates 36 and 38 that are spaced apart with proximate end sections of three fingers 41, 42 and 43 received there between. As seen specifically in FIGS. 4 and 5, the three fingers 41-43 curve in a common plane outward from the first and second plates 36 and 38 of the body 35. The three fingers 41, 42 and 43 rotate on the shafts of three rivets 44, 45 and 46, respectively, that extend through the first and second plates 36 and 38. The proximate end section of each finger 41-43 is enlarged and has gear teeth 48. Those gear teeth 48 mesh with the teeth of a circular gear 50 that is centrally located among the fingers 41-43 and is rotationally connected between the first and second plates 36 and 38 of the body. The circular gear 50 is attached to the drive coupling 32 and rotates when the drive coupling is driven by the wrench extension shaft 16 received in the square aperture 34 of the drive coupling. Rotation of the circular gear 50 inside the body 35 causes the three fingers 41-43 to pivot away from or toward the circumferential edges of the first and second plates 36 and 38, depending upon the direction of that rotation. FIGS. 3-5 depict the oil filter wrench 14 in a pivoted state in which the fingers 41-43 project outward approximately halfway along their travel range.

The fingers 41-43 are arcuate, curving alongside the circumferential edges of the first and second plates 36 and 38. As shown in FIG. 4, the remote end sections 51, 52, and 53 of the fingers 41, 42, and 43 respectively, that are opposite to the geared proximate end sections, bend upward toward the second plate 38 and project beyond the major exterior surface of the second plate. Thus the remote end sections 51-53 are transverse (e.g. orthogonal) to the common plane of the geared proximate end sections and the curving portions of the fingers 41-43. These bent fingers form a pocket in which the oil filter 25 is received when the removal tool 10 is in use, as shown in FIG. 2. The inner surface of each finger's remote end section 51, 52, and 53 has a projection, in the form of a rod 54, 55, and 56, projecting inwardly there from for grabbing the housing of the oil filter 25. For example, each rod 54-56 is illustrated as a set screw threaded into an aperture in the corresponding finger's remote end section 51-53 and preferably held therein by a thread locking compound, such as Loctite® brand. Although use of set screws enables the rods to be replaced, if necessary due to wear, unthreaded rods that are press fitted into the finger apertures, welded, or otherwise adhered thereto may be used as the projections for gripping the oil filter. The projections alternatively may be the rod or shaft of a machine screw or have a geometric cross section other than circular.

### INDUSTRIAL APPLICABILITY

To use the oil filter removal tool 10, the flexible boot 12 is slid over the oil filter 25 until the exposed end of the filter is received within the end sections 41-43 of the fingers 41-43 of the adjustable oil filter wrench 14, as shown in FIG. 2. If necessary, the boot 12 can deform to fit into a tight space around the oil filter. A wrench handle (not shown) is inserted into the square aperture 17 in the exterior end of the wrench extension shaft 16 and is used to rotate the extension shaft in a counter-clockwise direction. This rotation causes the circular gear 50 inside the wrench 14 to pivot the fingers 41-43 so that the inner ends of their rods 54-56 engage and firmly grip the housing of the oil filter 25 which is automatically centered in the wrench. The relatively small contact areas between the projecting rods and the oil filter housing concentrate the gripping force. Continued rotation of the oil filter wrench 14 causes the oil filter to rotate with the wrench, thereby loosening the filter from the engine. As that is occurring, the boot 12 can either rotate with the oil filter wrench 14 or remain stationary.

After a gap is created between the oil filter 25 and the engine, oil may leak there through. That leaking oil will drain into the boot 12 and be retained therein. Once the oil filter is free of the engine, the combination of the filter 25 and the removal tool 10 can be placed over a used oil receptacle and the oil poured from the boot through the open first end 19.

In some engines, a relatively large amount of oil remains in the attached oil filter and adjacent section of the engine after the oil pan has been drained. In this instance, before the oil filter 25 is loosened, the cap 28 is removed and a hose (not shown) is attached to the tubular drain coupling 26 of the boot. That hose leads to the used oil receptacle so that the leaking oil, caught in the boot 12 during the removal process, can immediately drain into that receptacle.

After the oil filter 25 has been removed entirely from the engine, the drive coupling 32 is rotated clockwise to release the grip of the fingers 41-43 on the filter housing, thereby enabling the oil filter to be taken out of the oil filter removal tool 10.

The foregoing description was primarily directed to one or more embodiments of the invention. Although some attention has been given to various alternatives within the scope of the invention, it is anticipated that one skilled in the art will likely realize additional alternatives that are now apparent from disclosure of embodiments of the invention. Accordingly, the scope of the invention should be determined from the following claims and not limited by the above disclosure.

1. A tool for removing an oil filter from an engine, said tool comprising:
a wrench having a body from which a plurality of fingers pivotally project, wherein each finger has a remote end section from which a rod extends in an orientation to engage the oil filter, the wrench further comprising a drive mechanism that when rotated causes the fingers to pivot with respect to the body;
a boot, of flexible material, having a frusto-conical shape with a first end that is open, and having a second end that is closed with a first aperture there through and that is smaller than the first end, wherein the wrench is located within the boot; and
a shaft attached to the drive mechanism of the wrench and extending through the first aperture of the boot.

2. The tool as recited in claim 1 wherein each rod of the wrench has screw threads and is threaded into an aperture in a respective one of the plurality of fingers.

3. The tool as recited in claim 1 wherein the boot has an exterior surface that curves inward going from the first end to the second end.

4. The tool as recited in claim 1 wherein the boot has a smooth exterior surface.

5. The tool as recited in claim 1 wherein the boot has an annular groove in an exterior surface.

6. The tool as recited in claim 1 wherein the boot further comprises a second aperture there through adjacent to the second end.

7. The tool as recited in claim 6 wherein the boot further comprises a removable closure preventing fluid from passing through the second aperture.

8. The tool as recited in claim 6 wherein the boot further comprises a coupling to attach a hose to the second aperture.

9. The tool as recited in claim 1 further comprising a collar affixed to a portion of the shaft that is inside the boot, wherein the collar is larger than the first aperture.

10. The tool as recited in claim 1 wherein the shaft has an exterior end with a square aperture therein.

11. The tool as recited in claim 1 wherein the wrench further comprises:
a circular gear that has teeth and that is rotationally connected to the body, wherein the drive mechanism is attached to the circular gear; and
wherein the plurality of fingers are pivotally connected to the body and curve outward there from in a common plane, each finger having a proximate end section with teeth that mesh with the teeth of the circular gear, and wherein the remote end section is transverse to the common plane.

12. A tool for removing an oil filter from an engine, said tool comprising:
a wrench having a body from which a plurality of fingers pivotally project, wherein each finger has a remote end section from which a rod projects in an orientation to engage the oil filter, the wrench further comprising a drive coupling that when rotated causes the fingers to pivot with respect to the body;
a boot, of flexible material, having a circular first end that is open, and having a circular second end that is closed with a first aperture there through and that is smaller than the first end, the boot having an annular exterior surface that curves inward going from the first end to the second end, wherein the wrench is located within the boot; and
a shaft attached to the drive coupling of the wrench and extending through the first aperture of the boot.

13. The tool as recited in claim 12 wherein each rod of the wrench has screw threads and is threaded into an aperture in a respective one of the plurality of fingers.

14. The tool as recited in claim 12 wherein the annular exterior surface is smooth.

15. The tool as recited in claim 12 wherein the boot has an annular groove in the annular exterior surface.

16. The tool as recited in claim 12 wherein the boot further comprises a second aperture there through adjacent to the second end.

17. The tool as recited in claim 16 wherein the boot further comprises a removable closure preventing fluid from passing through the second aperture.

18. The tool as recited in claim 12 wherein the wrench further comprises:
a circular gear with teeth and being rotationally connected to the body wherein the drive coupling is attached to the circular gear; and
wherein the plurality of fingers are pivotally attached to the body and curve outward there from in a common plane, each finger having a proximate end section with teeth that mesh with the teeth of the circular gear, and wherein the remote end section is transverse to the common plane.

19. A wrench for removing an oil filter from an engine, said wrench comprising:
body;
a circular gear that has teeth and that is rotationally connected to the body;
a drive coupling attached to the circular gear; and
a plurality of fingers pivotally connected to the body and curving outward there from in a common plane, wherein each finger has a proximate end section with teeth that mesh with the teeth of the circular gear and has a remote end section that is transverse to the common plane, each of the plurality of fingers has a rod projecting from the remote end section in an orientation to engage the oil filter;
wherein rotation of the drive coupling rotates the circular gear which causes the plurality of fingers to pivot with respect to the body.

20. The tool as recited in claim 19 wherein each rod has screw threads and is threaded into an aperture in a respective one of the plurality of fingers.
